(19) United States
(12) Patent Application Publication
(10) Pub. No.: US 2026/0290130 A1
(43) Pub. Date: Sep. 24, 2026

(54) Method and System for Full Season Fantasy Football Gameplay

(71) Applicant: Andrew J Fabiano, Buffalo, NY (US)

(72) Inventor: Andrew J Fabiano, Buffalo, NY (US)

(21) Appl. No.: 19/086,480

(22) Filed: Mar. 21, 2025

(51) Int. Cl. G07F 17/32; G06Q 50/34

(52) U.S. Cl. CPC G07F 17/3288; G06Q 50/34

(57) ABSTRACT

A method for season-long fantasy football gameplay allowing 2 to more than 1,000 game players to participate in season-long gameplay in the same League. Roster positions, scoring method, and method for determining League Champion are pre-determined prior to the start of the season. Each team selects a new roster of professional football players each week. A given professional football player may only be used once per season by each team. There is no limit on the number of teams that can use a particular player. This method allows for competitive season-long fantasy football gameplay between a very small or very large number of participants.

### CROSS-REFERENCE TO RELATED APPLICATIONS

No related applications.

### STATEMENT REGARDING FEDERALLY SPONSORED RESEARCH OR DEVELOPMENT

Not applicable.

### BACKGROUND OF THE INVENTION

### Field of the Invention

This invention is a unique scoring system for gameplay in fantasy football (previously referred to as rotisserie football). Fantasy football is a game of skill where the statistics of players in the National Football League (NFL) are used for game participants to compete against one another. It is estimated that 29.2 million people in the Unites States play fantasy football each season.¹ U.S. Pat. No. 8,315,722B1, U.S. Patent USRE44095E1, and U.S. Pat. No. 7,699,707B2 are examples of patents currently in place for Fantasy Sports scoring systems.²⁻⁴

A patent for a unique rule set for gameplay for fantasy football scoring is analogous to a patent for a unique rule set for gameplay with a standard deck of cards. Examples of patents for a unique rule set for gameplay with a standard deck of cards are U.S. Patent 5,380,012A, U.S. Patent US20220415136A1, U.S. Pat. No. 10,147,279B2, and U.S. Patent 5,660,391A.⁵⁻⁸

### Description of Related Art

There are currently two main categories of fantasy football scoring systems, full-season competition and daily fantasy competition. Full-season competition has a set number of teams select NFL players prior to the season as their Team. NFL players are most commonly selected through a draft or based on previous years'teams. The number of teams, and thus the number of game participants, is limited by the finite number of NFL players. Game participants then participate in either head-to-head, cumulative scoring, or both based on their NFL players'statistics over the course of the NFL's multi-week regular season to determine a Champion. This gameplay is typically limited to 14 or less participants based on available NFL players and is not conducive to less than 6 participants, as having less participants does not create enough scarcity of quality NFL players to test skill.

Daily fantasy competition involves a participant selecting NFL players for a fantasy competition involving only a single week of the NFL schedule. Any selections in prior weeks or future weeks are not affected by the choices for the single daily fantasy competition week. This type of scoring system involves a different skillset than full-season competition as factors such as bye weeks, injuries, and the impact of varying NFL matchups do not need to be accounted for in the same fashion. This scoring system only allows for a single week of play and not a season-long competition.

Once players are selected, in both full-season competition and daily fantasy competition, NFL player statistics are used to determine game participant performance. Points are allocated based on NFL player statistics. Typical statistics used for offensive player statistics include passing touchdowns, receiving touchdowns, rushing touchdowns, receptions, passing yards, receiving yards, rushing yards, fumbles, and sacks. Typical statistics used for defensive player statistics include touchdowns, tackles, sacks, forced fumbles, interceptions, and safeties. Typical statistics used for defensive team/special teams include return touchdowns, touchdowns, points against, sacks, forced fumbles, interceptions, and safeties. Typical statistics used for kicker are missed field goals, field goals 39 yards and under, field goals 40-49 yards, field goals 50 yard and over, and extra points.

### Need for the Invention

Despite 29.2 million yearly fantasy football participants in the United States and an estimated $8 billion gambled on fantasy football annually, no fantasy football scoring system currently exists to allow for a large number of game participants (e.g. more than twenty) to participate in a season-long fantasy football competition.^{1,9} The present invention allows for an unlimited number of participants in a season-long fantasy football competition. Further, presently available scoring systems do not provide a useful system for head-to-head (2 participants) or low (less than 6) number participants to engage in a full-season competition. The present invention provides a novel and useful way for such low participant full-season competitions to occur. The present invention provides a simpler method for season-long fantasy football gameplay that does not require a draft, waiver claims, or trades making it fundamentally different than present season-long fantasy football scoring systems.

### SUMMARY OF THE INVENTION

### Object of the Invention

The object of the Invention is to provide a fantasy football scoring system that allows a very small number or very large number (unlimited) of participants to play a season-long fantasy football game. There is currently no similar or available fantasy football scoring system that allows such gameplay.

### Brief Description of the Invention

The invention is a fantasy football method of play that differs from any presently available method of play. NFL players are selected each week to predetermined roster positions and each NFL player can only be used once per season by a given game participant, also known as fantasy football manager. The selected players'statistics in that given week determines points allotted to the fantasy football manager's team. Thus, each week the game participant will have a new roster of players, all starting with no bench players. This allows for season-long fantasy football play. It differs from present versions of season-long fantasy football as there is no roster carryover from week to week, no waiver wire, and no trades.

The league setup involves selecting roster positions for game play. For example, a league might select roster positions of 1 Quarterback (QB), 1 Running Back (RB), 2 Wide Receivers (WR), 1 Tight End (TE), 1 Flex (a player that can be a RB, WR, or TE), 1 Kicker (K), and 1 Team Defense and Special teams (D/ST). Positions are determined by NFL roster designations and preset in the fantasy method of play prior to the start of the season. Players started in each roster position earn points based on the statistics from their performance in that week's NFL game. The relative value of each statistic towards generating points is set prior to the season and remains constant for the season.

Prior to the start of the season the scoring system to be used to rank game participants (also described as teams) is determined. Weekly head-to-head scoring has two teams play each other each week with the team whose players generate the highest point total getting the win, and teams ranked during the season based on the number of wins. Alternatively, points can be cumulative with the included teams ranked at the end of the game's season based on points earned. Predefined playoff weeks can be used to determine an overall champion.

League composition, roster positions, player scoring, and determination of league champion are standard, ubiquitous fantasy football rules in current use. What is unique and valuable about the present invention is the game rule that each team may use a given NFL player only once per season and the competition lasts for the entire season. Success with this unique game play requires successfully identifying when a given player will have extreme success, taking into such factors as opponent matchup, weather, injuries, and game script. Given the length of the NFL season, this game play will require using a significant number of players requiring skill to select players beyond the known stars. Game players will require strategy if the desire to save talented players for the playoffs. As opposed to traditional scoring systems where an injury or bad preseason draft can render a team noncompetitive, this scoring system keeps players engaged for the entire season. This fantasy football scoring system will require a different strategy than traditional fantasy football season-long gameplay that involves roster moves, waiver wires, and trades.

On a weekly basis, each game participant will select the players they wish to start to earn points for their team. The following week, any previously selected players will be excluded from available players to use in their gameplay. Opposing players may start the same player, provided neither team has used that player in previous weeks. Given 32 NFL teams with numerous players at each position and typically 8 or more starting players per team, the potential permutations for starting lineups over the course of a season is more than 1 trillion. Thus, a potentially unlimited number of game participants is possible, unique to this scoring method. Additionally, this scoring method provides a much more challenging game play for a low number, such as 2-4 participants, for season-long gameplay then any presently available fantasy football scoring method.

### BRIEF DESCRIPTION OF THE DRAWINGS

Not required, see below.

### DETAILED DESCRIPTION OF THE INVENTION

The present invention is a novel method for fantasy football game play and season-long play. The invention introduces a scoring system that allows for very few (2-3) participants, the typical number of fantasy football league participants (8-14), or very many (more than 50 to potentially unlimited) participants. No fantasy football scoring system and method of gameplay currently exists that allows this type of gameplay to occur. The salient rules that allow for this gameplay is that each roster is constructed on a week-to-week basis and each team may only use a given NFL player once per season, while a given NFL player may used once per season by all involved teams.

### Core Components of the Invention

1. Roster Construction—Each game participant's roster will be determined on a weekly basis. There is no player draft and no players are maintained on a given team's roster from week to week. A complete novel roster of players who will all participate in team scoring is selected each week by each participating team manager. Team managers may not select players who they have used on their roster in previous weeks. Opposing teams may select the same player provided they have not used that player in a previous week.
2. Positions Scored—The player and team positions used for scoring each week will be determined by the League Commissioner or organizing body prior to the start of the season and will remain constant for the season. NFL player position designations will be determined by that player's listed position on their official NFL Team Roster. Positions will be selected from the commonly used fantasy football positions including but not limited to Quarterback, Running Back, Wide Receiver, Tight End, Flex (Wide Receiver or Running Back), Flex (Wide Receiver, Running Back, or Tight End), Kicker, Defense/Special teams, and Individual Defensive Player. The League Commissioner or organizing body may choose to include more than one player at certain positions on the roster to be scored. For a given team a player may only be used once per season regardless of position. For example, a player who has previously been used by a team as a Running Back may not later be used by that same team as a Flex.
3. Scoring—Game is based on the statistics achieved by the NFL players selected to each team's roster. Numerous fantasy football scoring formats exists and are widely available for use.¹⁰ Typical scoring formats provide points for statistics such a passing/rushing/receiving touchdowns, passing/rushing/receiving yards gained, receptions, 2 pt conversions, field goals, sacks by defense, fumbles and interceptions by defense. Players may lose points for fumbles lost, interceptions thrown, or missed field goals. Players may receive bonus points for certain statistical achievements such as 100 yards rushing or receiving or 300 yards passing. The League Commissioner or organizing body determines at the start of the season what scoring system will be used from available scoring formats or devises their own scoring format. The same scoring format is used for the entirety of the season.
4. Season Setup—The League Commissioner or organizing body determines at the start of the season the season setup. A typical format is that teams will face head-to-head with other league teams on a weekly basis and the team with a greater point total achieved by the players on their roster for that week is awarded a win. The schedule for head-to-head weekly competition is determined at the start of the season. The teams are ranked in order according to which team has the most wins. Prior to the start of the season the number of teams that will advance to the playoffs is determined. Top teams advance to the playoffs where they are seeded by their wins obtained and total points. Head-to-head competition continues in a single elimination tournament until a Champion is determined.

Variations of season setup are possible through this scoring system. Ranking teams based on total points achieved through the season in a cumulative fashion is one such variation. Rankings based cumulative point total through the entire season is a particularly useful season setup that takes advantage of this unique scoring system and method to allow a competitive game when there are only 2 participants or there are many (more than 1000) participants. No fantasy football scoring system and method presently exists to allow for a viable competitive season long game between more than 1000 participants but the presently described fantasy football scoring system and method makes such a competition possible.
5. Strategic Depth—The present novel scoring system allows for new areas of strategy not present in contemporary fantasy football gameplay. Team Managers will now have to select in which week they will use top players. Player's opposition, bye weeks, and injuries will factor into decisions. Team Managers may choose to stack players from a particular team in a week if they predict a strong output from that team in that particular week. Team Managers will also have to consider saving players for more important head-to-head matchups or the playoffs. In summary this novel scoring system provides for novel strategic depth in a fantasy football competition.

### Implementation Details

The present novel method for fantasy football scoring and gameplay can be implemented via any number of software platforms that presently exist for fantasy football game play. Such software systems obtain statistical data directly from the National Football League. National Football League statistics are publicly available and game participants may also manually score games using publicly available data.¹¹

### Advantages of the Invention

The present scoring method provides utility as it is the first to allow season-long gameplay by a large (greater than 50) number of participants. The scoring system provides a wide range of participant numbers and even offers the advantage of a competitive season-long head-to head format. The present invention provides a novel and exciting format for fantasy football gameplay, a game enjoyed by 29 million individuals each year. Given the interest and profitability of fantasy football, the lack of a similar scoring system or otherwise that allows for season-long gameplay by many participants demonstrates the novelty and non-obviousness of the presently described scoring system.

1. A method for season-long fantasy football gameplay comprising:
a. Use of real-world statistics from professional football players;
b. Each player participating in the gameplay may act as a Team Manager of an individual Team;
c. Each Team selects a roster of players at pre-defined positions on a weekly basis;
d. Each Team may only use a particular player one time per season;
e. Weekly scoring is determined by pre-determined statistical point allocations;
f. There is no limit on the number of Teams that can use a particular player;
g. Method for determining League Champion (game winner) is based on team performance and is pre-determined prior to the start of the season.

2. The method of claim 1, wherein the season-long fantasy football league gameplay includes:
a. No player draft;
b. No season-long team roster;
c. No player trades;
d. No waiver wire.

3. The method of claim 1, wherein season-long fantasy football gameplay allows 2 to more than 1,000 game players to participate in season-long gameplay in the same League.

4. The method of claim 1, wherein two Teams may use the same player in the same week provided neither Team has used that player previously in the season.
